(19) United States
(12) Patent Application Publication
(10) Pub. No.: US 2012/0163618 A1
(43) Pub. Date: Jun. 28, 2012

(54) AUDIO TRANSMISSION SYSTEM

(75) Inventor: YAN-BIN LI, Shenzhen (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/164,764

(22) Filed: Jun. 20, 2011

(30) Foreign Application Priority Data
Dec. 27, 2010 (CN) 201010607367.1

(51) Int. Cl. H04B 7/00

(52) U.S. Cl. 381/77

(57) ABSTRACT

An audio transmission system includes a first communication module, a second communication module, a microphone a receiver, and an antenna. The microphone receives an analog audio signal from users. The first and second communication modules convert the analog audio signal into a first or third RF signal. The antenna sends the RF signal to other portable electronic devices. The first and second communication modules also receive a second or forth RF signal from other portable electronic devices via the antenna and convert the second or forth RF signal into an analog audio signal. The receiver outputs the analog audio signal to the users.

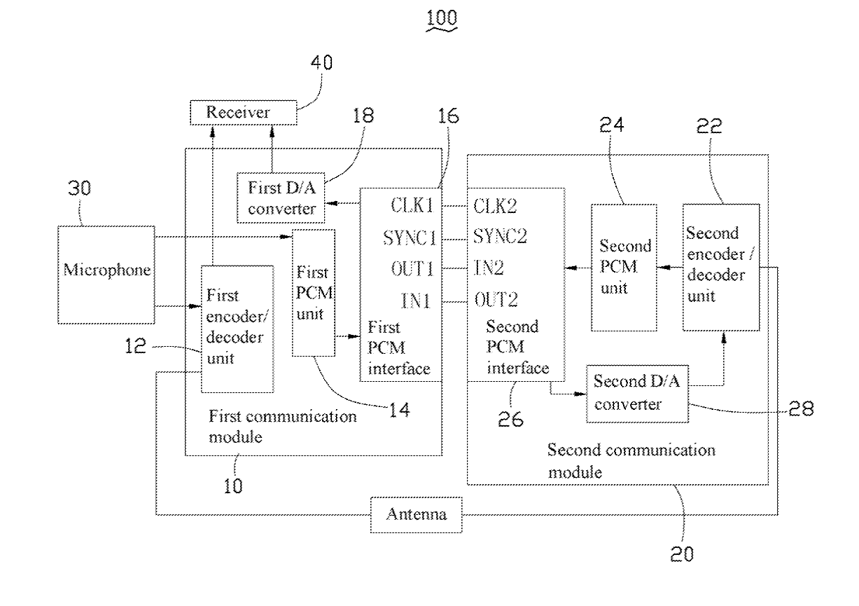

### BACKGROUND

1. Technical Field

The disclosure generally relates to audio transmission systems, and particularly to an audio transmission system for dual mode communication.

2. Description of Related Art

Wireless communication technologies, such as Code division multiple access (CDMA) and Global System for Mobile (GSM), are rapidly developing. Many mobile phones include two types of communication modules to support dual-mode communication. During communication, switches are commonly used to select a desired communication module to connect to speakers and microphones of the mobile phones. However, too many switches may lead to an overly complex structure and a high price for the mobile phones.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

The FIGURE is a block diagram of an audio transmission system used in a portable electronic device, according to an exemplary embodiment.

### DETAILED DESCRIPTION

The FIGURE is a block diagram of an audio transmission system 100 used in a portable electronic device, according to an exemplary embodiment. The audio transmission system 100 includes a first communication module 10, a second communication module 20, a microphone 30, a receiver 40 and an antenna 50. The second communication module 20, the microphone 30 and the receiver 40 are connected to the first communication module 10. The antenna 50 is connected to the first communication module 10 and the second communication module 20.

The audio transmission system 100 can be used in a first and second communication mode. In this exemplary embodiment, the first communication module 10 is a CDMA signal processing microchip, and supports the audio transmission system 100 to be used in a CDMA communication mode; and the second communication module 20 is a GSM signal processing microchip, and supports the audio transmission system 100 to be used in a GSM communication mode.

The first communication module 10 includes a first encoder/decoder unit 12, a first pulse code modulation (PCM) unit 14, a first PCM interface 16, and a first digital to analog (D/A) converter 18.

The first encoder/decoder unit 12 is connected to the microphone 30, the receiver 40 and the antenna 50. In the CDMA communication mode, the first encoder/decoder unit 12 receives a first analog audio signal from the microphone 30. The first encoder/decoder unit 12 encodes the received first analog audio signal into a first RF signal and send the first RF signal to the antenna 50. The first encoder/decoder unit 12 receives a second RF signal from the antenna 50. The first encoder/decoder unit 12 decodes the received second RF signal into a second analog audio signal and sends the second analog audio signal to the receiver 40.

The first PCM unit 14 is connected to the microphone 30 and the first PCM interface 16. In the GSM communication mode, the first PCM unit 14 receives the first analog audio signal from the microphone 30. The first PCM unit 14 processes (i.e. samples and encodes) the first analog audio signal and converts the processed first analog audio signal into a first digital audio signal.

The first PCM interface 16 is connected to the first PCM unit 14, the first D/A converter 18, and the second communication module 20. In the GSM communication mode, the first PCM interface 16 sends the first digital audio signal from the first PCM unit 14 to the second communication module 20. The first PCM interface 16 also receives second digital audio signal from the second communication module 20 and sends the received second digital audio signal to the first D/A converter 18.

In this exemplary embodiment, the first PCM interface 16 includes a clock terminal CLK1, an output terminal OUT1, an input terminal INL and a synchronization terminal SYNC1. The clock terminal CLK1 controls frequency of sending/receiving the first and second digital audio signals. The output terminal OUT1 outputs the first digital audio signals from the first PCM unit 14 to the second communication module 20. The input terminal IN1 inputs the second digital audio signals from the first PCM interface 16 to the D/A converter 18. The synchronization terminal SYNC1 insures the sent/received first and second digital audio signals consistent.

The first D/A converter 18 is connected to the first PCM interface 16 and the receiver 40. In the GSM communication mode, the first D/A converter 18 convert the second digital audio signal from the second communication module 20 back to a third analog audio signal and sends the third analog audio signal to the receiver 40. The receiver 40 may be a speaker or an earphone, which outputs the third analog audio signals to the user.

The second communication module 20 has a structure substantially similar to the first communication module 10. The second communication module 20 includes a second encoder/decoder unit 22, a second PCM unit 24, a PCM interface 26, and a second D/A converter 28.

The second encoder/decoder unit 22 is connected to the second PCM unit 24, the D/A converters, and the antenna 50. In the GSM communication mode, the second encoder/decoder unit 22 receives the first analog signals from the D/A converter 28, decodes the first analog signals into third RF signals, and then sends the third RF signals to the antenna 50.

The second encoder/decoder unit 22 also receives a fourth RF signal from the antenna 50. The second encoder/decoder unit 22 decodes the received fourth RF signal into a third analog signal and the sends the third analog signal to the second PCM unit 24.

The second PCM unit 24 is connected to the second PCM interface 26. In the GSM communication mode, the second PCM unit 24 receives the third analog signal from the second encoder/decoder unit 22. The second PCM unit 24 processes (i.e. samples and encodes) the third analog audio signal and converts the processed third analog audio signal into the second digital audio signal.

The second PCM interface 26 is connected to the first PCM interface 16. In the GSM communication mode, the second PCM interface 26 sends the second digital signal from the second PCM unit 24 to the first PCM interface 16. In addition, the second PCM interface 26 receives the first digital signal from the first PCM unit 14, and sends the first digital signal to the second D/A converter 28.

In this exemplary embodiment, the second PCM interface 26 is substantially similar to the first PCM 16 and includes a clock terminal CLK2, an output terminal OUT2, an input terminal IN2, and a synchronization terminal SYNC2. The clock terminal CLK2 is connected to the clock terminal CLK1 of the first PCM interface 16. The synchronization terminal SYNC2 is connected to the synchronization terminal SYNC1 of the first PCM interface 16. The output terminal OUT2 is connected to the input terminal IN1 of the first PCM interface 16. The input terminal IN2 is connected to the output terminal OUT1 of the first PCM interface 16.

The second A/D converter 28 is set between the second encoder/decoder unit 12 and the PCM interface 16. The second A/D converter 28 receives the first digital signal from the first PCM unit 14, converts the first digital signal back into the first analog audio signal, and then sends the first analog audio signal to the second encoder/decoder unit 22.

In a CDMA communication mode, the first analog audio signal is sent to the first encoder/decoder unit 12 from the microphone 30. The first encoder/decoder unit 12 encodes the first audio signal into the first RF signal. The antenna 50 receives the first RF signal and transmits the first RF signal to other portable electronic devices. In other aspects, the antenna 50 receives a second RF signal from other portable electronic devices and sends the second RF signal to the first encoder/decoder unit 12. The first encoder/decoder unit 12 decodes the RF signal into second analog audio signal and sends the second analog audio signal to the user.

In a GSM communication mode, the first analog audio signal of the user is sent to the second PCM unit 24 from the microphone 30. The second PCM unit 24 processes and converts the first analog audio signal into the first digital audio signal, and sends the first digital audio signal to the second D/A converter 18 by the first PCM interface 16 and the second PCM interface 26. Then, the second D/A converter 18 converts the first digital audio signal back into the first analog audio signal. The first encoder/decoder unit 12 encodes the first analog audio signal to a third RF signal. The antenna 50 receives the third RF signal and transmits the third RF signal to other portable electronic devices.

In other aspects, the second encoder/decoder unit 22 receives a fourth RF signal from the antenna 50, and decodes the fourth RF signal from the antenna 50 into a third analog audio signal and sends the third analog audio signal to the second PCM unit 24. The second PCM unit 24 processes the third analog audio signal, and coverts the third analog audio signal into the second digital signal. The second digital signal is sent to the first D/A converter 18 by the second PCM interface 26 and the first PCM interface 16. The first D/A converter 18 convert the second digital signal into a third analog signal. The receiver 40 outputs the third analog signal to the users.

The second communication module 20 can be connected to the receiver 40 by the PCM interface. The audio transmission system 100 does not need to switch members to select the first communication module 10 or the second communication module 20 to the microphone 30 and the receiver 40. Thus, the audio transmission system 100 has a simple structure.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An audio transmission system, comprising:
a first communication module;
a second communication module;
a microphone;
a receiver; and
an antenna; wherein in a first communication mode, the first communication module receives a first analog audio signal from the microphone, and encodes the first analog signal into a first RF signal, the antenna transmits the first RF signal; the first communication module also receives a second RF signal from the antenna, and decodes the second RF signal into a second analog audio signal, and the receiver outputs the second analog audio signal;
in a second communication mode, the second communication module receives a first digital audio signal from the first communication module, and converts the first digital audio signals back to the first analog audio signal, the second communication module encodes the first analog audio signals into a third RF signal, the antenna transmits the third RF signal; the second communication module also receives a fourth RF signal from the antenna and decodes the fourth RF signal into a third analog audio signal, the receiver receives the third analog audio signal by the first and second communication modules and outputs the third analog audio signal.

2. The audio transmission system as claimed in claim 1, wherein the first communication module includes a first encoder/decoder unit, a first pulse code modulation (PCM) unit, a first PCM interface, and a first digital to analog (D/A) converter; the first encoder/decoder unit encodes the first analog audio signal from microphone to the first RF signal, and sends the first RF signals to the antenna; the first PCM unit receives the first analog audio signal from the microphone and converts the first analog audio signal to the first digital audio signal; the first PCM interface sends the first digital signal from the first PCM unit to the second communication module; the first D/A converter converts second digital audio signal from the second communication module back to the third analog audio signal.

3. The audio transmission system as claimed in claim 2, wherein the second communication module includes a second encoder/decoder unit, a second PCM unit, a PCM interface, and a second D/A converter; the second encoder/decoder unit decodes a fourth RF signal from the antenna into the third analog signal and the sends the third analog signal to the second PCM unit; the second PCM unit converts the third analog audio signal into second digital signal and sends the second digital signal to the first D/A converter by the second PCM interface; the second D/A converter receives the first digital signal and converts the first digital signal back to the first analog signal, the second encoder/decoder unit encodes the first analog signal into third RF signal and sends the third RF signal to the antenna.

4. The audio transmission system as claimed in claim 1, wherein the first PCM interface includes a clock terminal, an output terminal, an input terminal, and a synchronization terminal; the clock terminal, the output terminal, the input terminal, and the synchronization terminal are connected to the second PCM interface.

5. The audio transmission system as claimed in claim 4, wherein the second PCM interface includes a clock terminal connected to the clock terminal of the first PCM interface, an output terminal connected to the input terminal of the first PCM interface, an input terminal connected to the output terminal of the first PCM interface, and a synchronization terminal connected to the synchronization terminal of the first PCM interface.

6. The audio transmission system as claimed in claim 1, wherein the first communication module is a CDMA signal processing microchip.

7. The audio transmission system as claimed in claim 1, wherein the second communication module is a GSM signal processing microchip.
